(19) United States
(12) Patent Application Publication
(10) Pub. No.: US 2010/0228486 A1
(43) Pub. Date: Sep. 9, 2010

(54) METHOD AND SYSTEM FOR SEISMIC DATA PROCESSING

(76) Inventors: RenChu Wu, Beijing (CN); QingRui Li, Beijing (CN); Gang Fan, Beijing (CN); Rui Zeng, Beijing (CN); Min Tang, Beijing (CN); Dong Wang, Beijing (CN); YuanYuan Xu, Beijing (CN)

Correspondence Address: HOFFMAN WARNICK LLC, 75 STATE STREET, 14TH FLOOR, ALBANY, NY, 12207, US

(21) Appl. No.: 12/399,161

(22) Filed: Mar. 6, 2009

(51) Int. Cl. G01V 1/28; G06F 19/00

(52) U.S. Cl. 702/17

(57) ABSTRACT

The present invention relates to methods for data processing, particularly seismic data represented in three dimensions (3D). A method in accordance with one embodiment of the invention includes identifying extrema points from the 3D seismic data set; removing artificial distortion from 3D seismic data set; generating extrema cubes and derivatives along extrema points; estimating a class number associated with the extrema points; and determining number of classes and dynamically classifying extrema points.

### BACKGROUND OF INVENTION

1. Field of the Invention

This invention relates to the field of seismic data processing. In particular, the invention relates to seismic data pre-processing for extrema classification and Extrema Sequence classification.

2. Background

Seismic data acquisition and processing are key components in geophysical exploration. Seismic data are collected in order to analyze the subsurface of the Earth, in particular for hydrocarbon exploration. The seismic signals released from a seismic source, which may comprise explosives or an impulse of compressed air. The signals reflected by the various layers beneath the surface of the Earth are known as traces and are sensed by a larger number, typically hundreds of sensors such as geophones. The reflected signals are recorded and the results are analyzed to derive an indication of the layer formations beneath the subsurface. In a seismic survey, formation layers, lithological boundaries, sedimentary bedding, etc. can be defined through the interface between different formation layers, which produces seismic reflections due to impedance contrast.

Seismic reflections are referred as seismic horizons, which is important in structural characterization of 3D seismic data. Seismic horizons are commonly interpreted as being located along minimum, maximum, or zero crossing value in a seismic volume. Various seismic data processing methods, including manual interpretation and automatic extraction of the seismic horizon have been developed. U.S. Pat. No. 7,248,539, issued to Borgos et al., discloses a method of automatic seismic reflector interpretation and fault displacement calculations. The method provides a sophisticated automatic approach for extracting interpretation primitives using a sub-sample precision algorithm that also computes attributes for each primitive. Thus, fast and accurately merging the interpretation primitives into geological structures. According to Borgos' method, generating extrema cubes is a basic and one of the most important part of the process. The term “extrema” as used throughout this patent application includes any characters or seismic traces that can be used to track the position of seismic horizons, such as minimum values, maximum values, zero-crossing values and midpoints between zero-crossing values and maximum or minimum values, etc. According to Borgos', high accuracy positions of extrema points can be calculated by orthogonal polynomial reconstruction of seismic traces. However, for some reasons, the seismic measurement data may contain distortions and the seismic traces are not always continuous and valid. Thus, the positions and the amplitudes of the extrema points derived from the distortions are useless, which causes faults in the resulting extrema cubes and seismic interpretation faults.

Another important feature of Borgos' method is to classify seismic waveforms around the reflectors, thus, provided an improved automatic interpretation. However, such classification relies on the user to decide the right number of classes to produce. It is always hard for the user to view and decide, because the samples to be classified are typically 3 dimensional. Thus, users have to guess a number and take hours to produce the result, and maybe another couple of hours for another number of classes.

### SUMMARY OF INVENTION

In one aspect, the present invention relates to methods for data processing, particularly seismic data represented in three dimensions (3D). A method in accordance with one embodiment of the invention includes identifying extrema points from the 3D seismic data set; removing artificial distortion from 3D seismic data set; generating extrema cubes and derivatives along extrema points; estimating a class number associated with the extrema points; and determining number of classes and dynamically classifying extrema points.

In another aspect, the present invention relates to methods for reducing artificial distortion from 3D seismic data set. In accordance with one embodiment of the invention, a method for processing 3D seismic data set comprises selecting a seismic trace from the 3D seismic data set; removing dead trace data from the seismic trace; extracting extrema points from the seismic trace; removing extrema points by comparing distance between adjacent extrema points and characteristics of the adjacent extrema points; and outputting remaining extrema points.

In another aspect, the present invention relates to methods for auto-estimating class number for extrema classification or extrema sequence classification. In accordance with one embodiment of the invention, a method for processing 3D seismic data set comprises extracting extrema points from the 3D seismic data set; K-mean clustering the extracted extrema points into N clusters; calculating Gaussian parameters of each cluster; grouping clusters according to the Gaussian parameters of all clusters; and outputting amount of groups as class number for extrema classification or extrema sequence classification.

### BRIEF SUMMARY OF THE DRAWINGS

FIG. 1 shows a work flow of seismic data processing according to one embodiment of the present invention.

FIG. 2 shows a process of distortion reduction according to one embodiment of the present invention.

FIG. 3 shows a process of auto-estimating class number in accordance with one embodiment of the invention.

FIG. 4 shows a display of a seismic trace including a serious seismic sample data and corresponding distortions.

FIG. 5 shows a display of extracted horizon in a section plane of 3D seismic data set.

FIG. 6 shows a display of a seismic trace having clamped values.

FIG. 7 shows a display of a dead trace area in a section plane of 3D seismic data set.

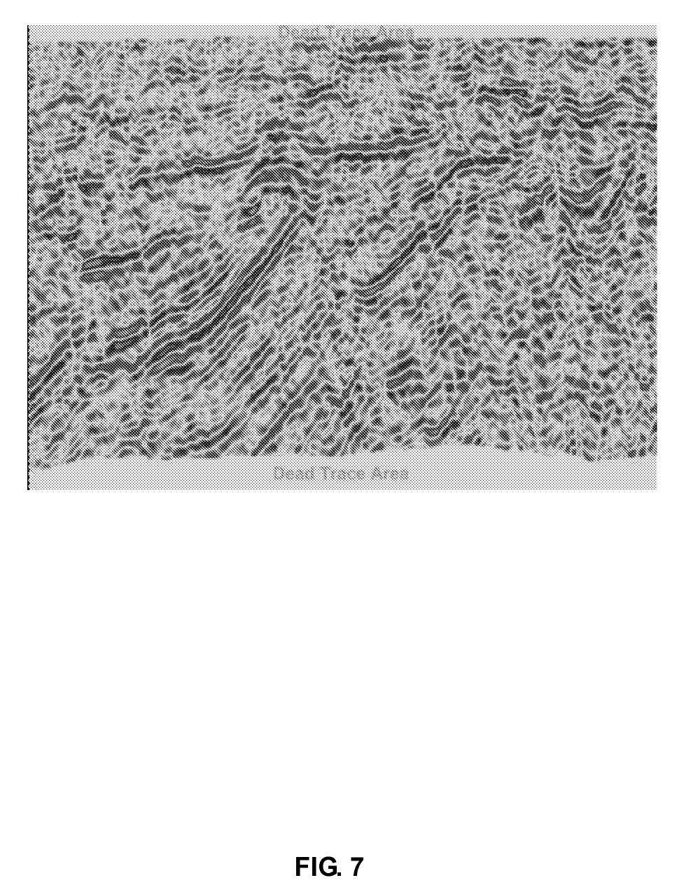

### DETAILED DESCRIPTION

U.S. Pat. No. 7,248,539, issued to Borgos et al., the disclosures of which are incorporated here by reference, discloses a method of Extrema Classification, which discloses generating extrema points by using Taylor expansion method. However, the generated points can only be called extrema points in theory, because the raw seismic measurement data always include noise. These extrema points derived from raw measurement data may result in unacceptable seismic interpretations. Normally, the user has to manually identify the interpretation faults and remove those. Since most of these interpretation faults originate from the fake extrema points generated in the previous detection step, better interpretation results could be achieved by removing the artificial distortions before the step of extrema point detection.

According to an embodiment of the invention, the distortions and noise of the seismic database can be categorized in three main types that are useless dithering, clamped values and dead traces.

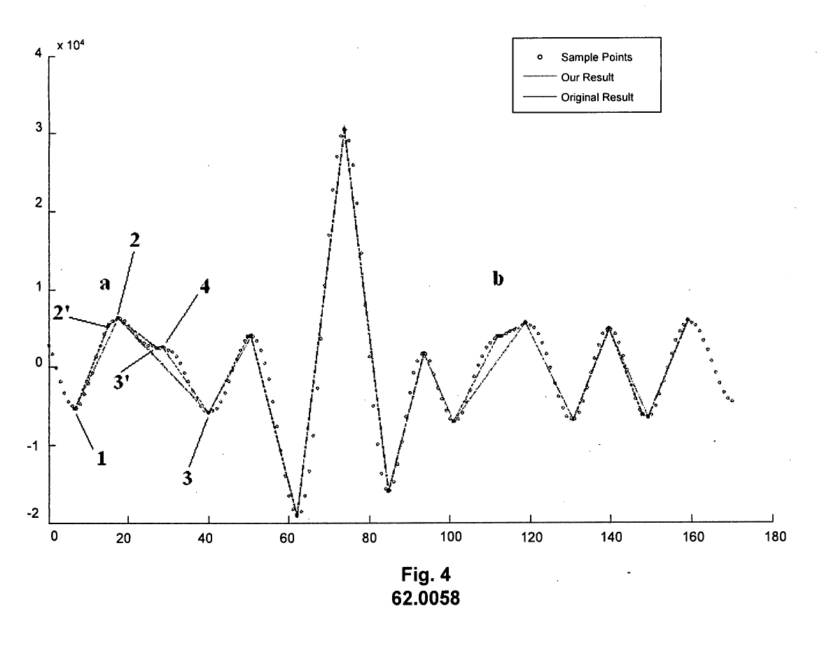

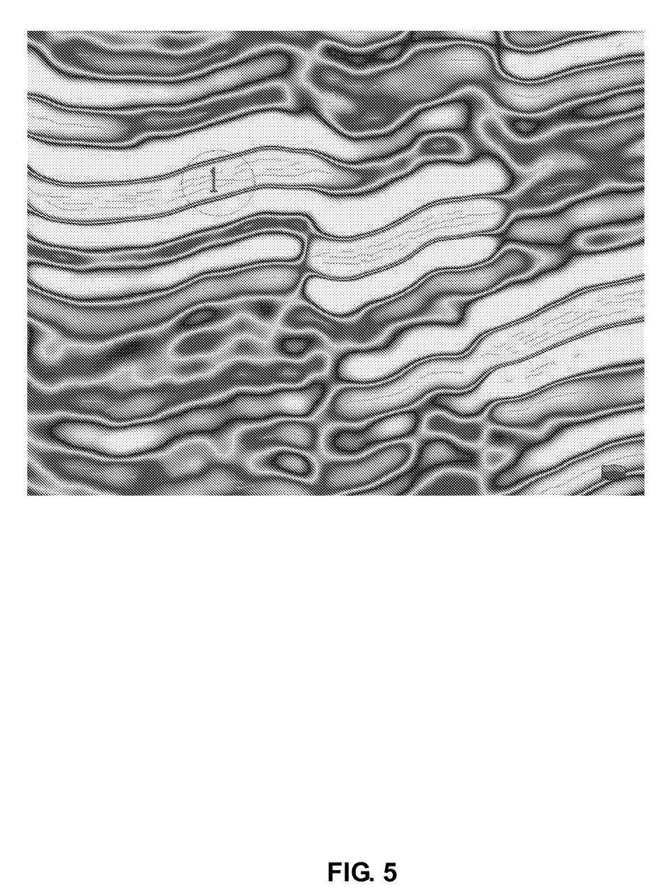

1. Useless dithering: FIG. 4 illustrates a useless dithering case. The small circles represent samples of the seismic measurement data. The small circles line up in a seismic trace, which is typically in the form of sine wave. The seismic trace also includes distortions. As shown in FIG. 4, distortions appear to be protrusions that deviate from the sine wave, for example, the protrusions at location a and location b of FIG. 4. Those protrusions will normally be extracted as extrema points by existing technique. Thus, without any pre-processing to the seismic measurement data, the distortions in the measurement data could later become extrema points that do not actually exist at all. FIG. 5 shows that if we do not remove these fake extrema points originated from the distortions, 3 horizons will be generated instead of 1 horizon at location 1. That is an example about how measurement data distortions could affect the seismic interpretation result.

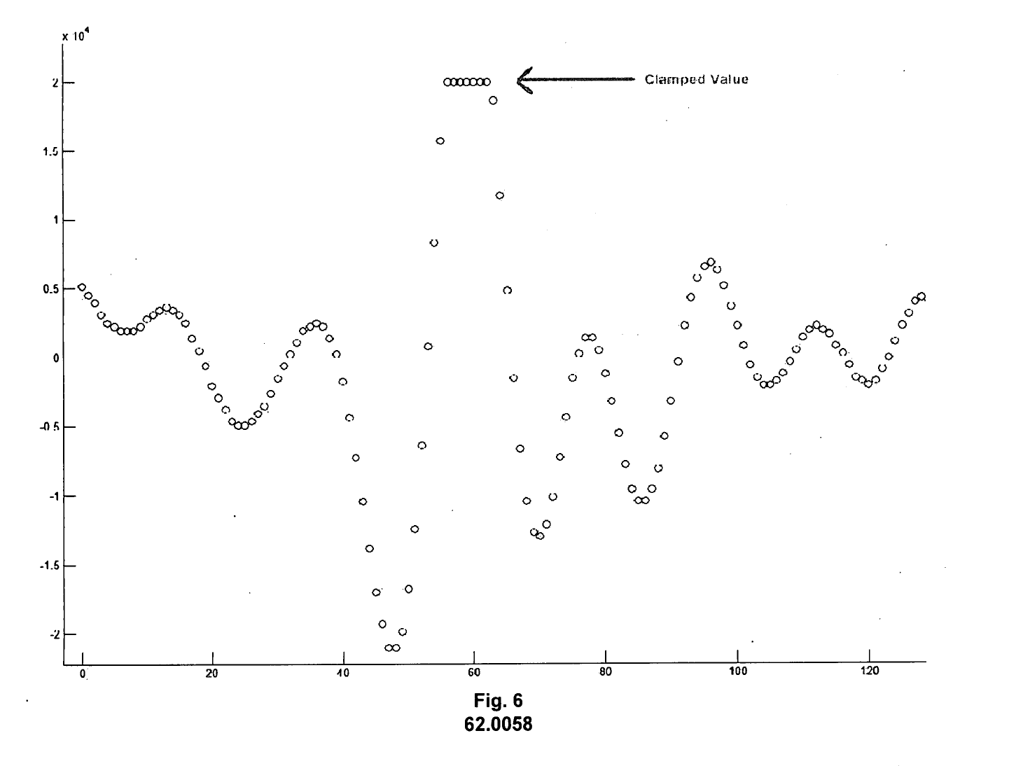

2. Clamped value: The clamped values are actually distortions caused by the data processing of data acquisition tools. Some acquisition tools do rough pre-processing that replaces data having amplitude more than threshold amplitude with the threshold. As shown in FIG. 6, a seismic data trace more than threshold amplitude is “cut off” by a straight line of threshold. Thus, the peak of that wave is replaced by a straight line. By the following curve fitting step, the line of modified sample points will be fitted by a serious of sine waves, and the peaks of the serious sine wave could become a serious of fake extrema points. As discussed above with respect to “useless dithering”, those fake extrema points could latterly become fake seismic horizons and interpretation faults.

3. Dead trace: Dead traces are caused by the rough data processing by data acquisition tools. Seismic data are reflections captured by geophones, and the captured reflections are time-indexed. In order to demonstrate the subsurface formation, the received reflections need to be transformed from time domain to depth domain. This transformation could also cause distortions. For instance, a seismic wave propagates faster in rigid formation layers than in loose or porous layers, and the depth interval for each sampling in rigid layers will be longer. That could result in the depth errors of the seismic traces. In order to compensate the depth errors, acquisition tools normally scale down a portion of seismic trace for a loose formation layer and fill the break with a straight line of zero amplitude. This straight line with zero amplitude does not include any meaningful data. In extrema extraction and classification process, the breaks of the seismic data traces should not be considered. Thus, each individual trace needs to be check and meaningless samples need to be removed from the trace.

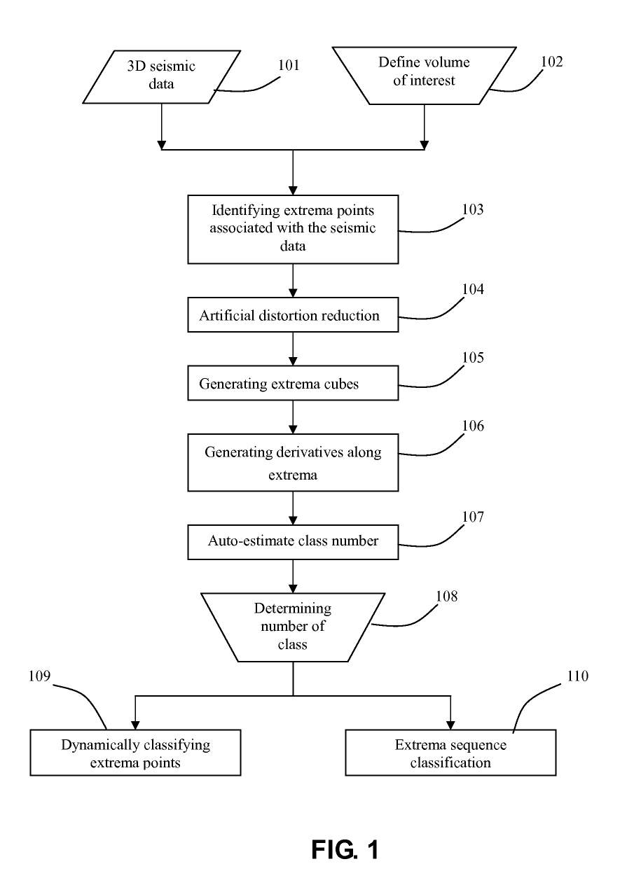

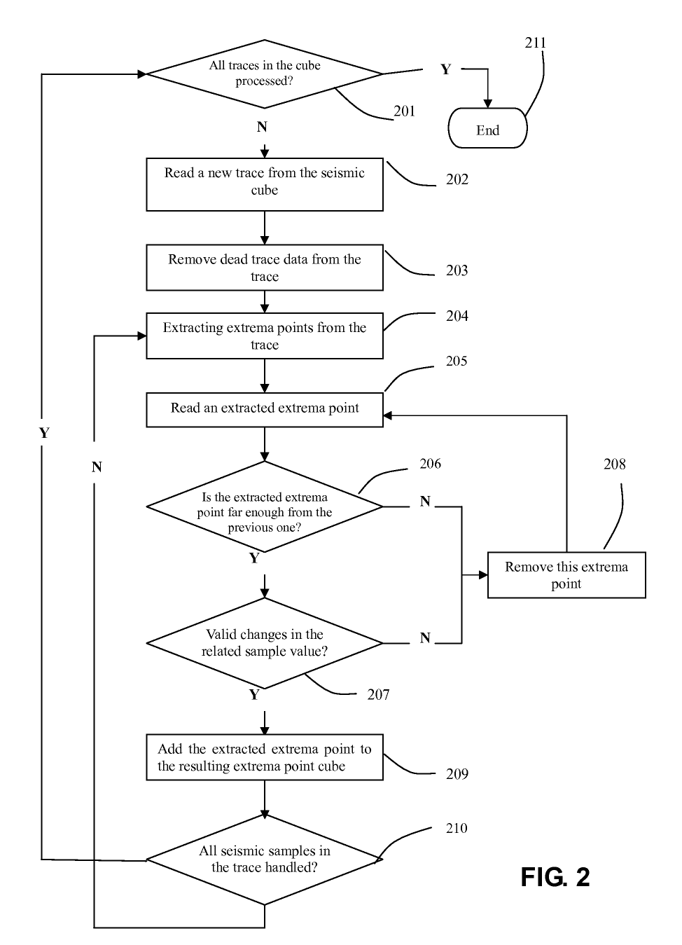

According to an embodiment of the invention, as shown in FIG. 1, a method for pre-processing 3D seismic data starts with obtaining 3D seismic data 101. Manually defining a volume of interest within the 3D seismic data 102. Then, identifying extrema points from the 3D seismic data 103. Artificial distortion reduction step 104 comprises removing useless dithering, clamped values and dead traces. The artificial distortion reduction step 104 will be more specifically explained in the following paragraphs by reference with FIG. 2. After reducing the distortion, extrema cubes will be generated 105.

According to an embodiment of the present invention, generating extrema cubes 105 involves reconstructing the seismic traces by using orthogonal polynomials, which is described in significantly more detailed in U.S. Pat. No. 6,240,370, issued May 29, 2001 to Las Sonneland et al. Orthogonal polynomial reconstruction provides an analytic representation of the seismic signal from which high accuracy positions of extrema points can be calculated. The resulting extrema points may be represented through two sparse 3D volumes. One of the extrema cubes may contain the amplitudes of the extrema points, positioned at the voxels vertically closest to the extrema points. If the types of extrema being identified are zero-crossings, then a non-zero placeholder value (such as 1.0) could be used to mark the identified voxels. Voxels between extrema points are generally assigned zero value. A second cube contains values describing the vertical distances between the voxel positions where the amplitudes are stored, and the exact positions of the extrema, i.e., the sub-sample precision. The set of voxels containing extrema data is the same for the two cubes, but they contain amplitude and sub-sample position values respectively.

After the extrema cubes being generated 105, derivatives along extrema points will be generated 106. According to one embodiment of the invention, the derivatives/coefficients characterize the seismic data in the vicinity of the extrema positions. The derivatives can be calculated by reconstructing seismic signals or the entire seismic trace in vicinity of the extrema point, which is described in significantly more detailed in U.S. Pat. No. 6,240,370, issued May 29, 2001 to Las Sonneland et al.

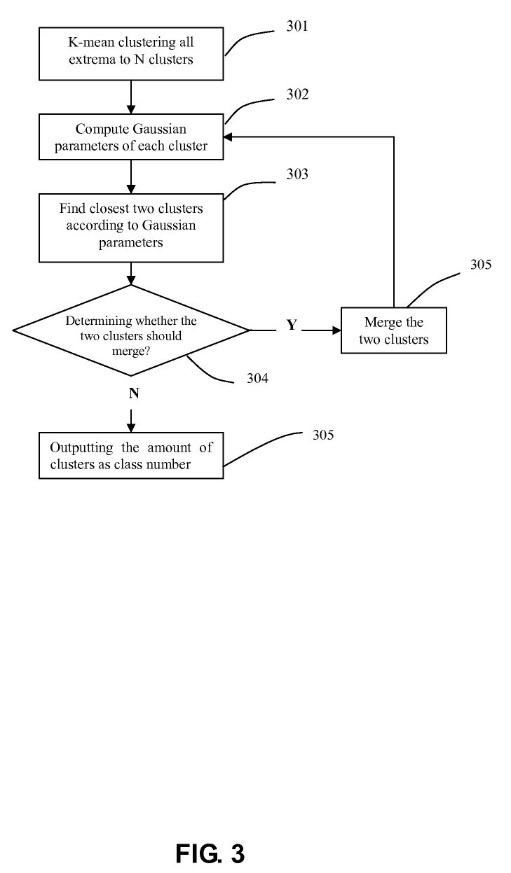

Then, auto-estimating class number 107. The step of auto-estimating class number will be more specifically explained in the following paragraphs by reference of FIG. 3. In viewing the result of auto-estimating class number step 107, the user manually determines a number of classes 108, as shown in FIG. 1. The resulting class number can be used to extrema classification 109 and extrema sequence classification 110 that are described in significantly more detailed in U.S. Pat. No. 7,248,539, issued Jul. 24, 2007 to Borgos et al.

According to an embodiment of the invention, the step of artificial distortion reduction starts with determining whether all traces in the cube have been processed 201. As shown in FIG. 2, if all of the traces have been processed, the artificial distortion ends 211. If not all traces have been processed, reading a trace from the seismic cube 202. Then, removing dead trace data from the trace 203. After all dead trace data have been removed, extracting extrema points from the trace 204. Reading one of the extracted extrema points 205. Then, determining whether the extracted extrema point is far enough from the previous one 206. If the extrema point is far enough from the previous one, determining whether there are valid changes in the related sample values 207. If no valid changes in the related sample value, removing this extrema point from the extrema cubes 208 and go back to step 205 to read another extracted extrema point. If there has been valid change in the related sample value, add the extrema point to the resulting extrema point cubes 209.

According to an embodiment of the invention, determining whether there are valid changes in the related sample values includes comparing the characteristics of every two contiguous extrema points. The characteristics include, for example, whether an extrema point has a maximum value, minimum value or zero crossing value. As shown in FIG. 4, extrusions 1, 2′, 2, 3′, 4 and 3 are scattered along the wave of sample points and are extracted as extrema points. As described in the foregoing paragraph, step 206 determining whether the extracted extrema point is far enough from the previous one. The sample point 2′ is not far enough from the sample point 2; and the sample point 3′ is not far enough from the sample point 4. Since the values of sample points 2 and 4 are higher than the values of sample points 2′ and 3′. Thus, sample points 2′ and 3′ should not be considered as extrema points, although sample points 2′ and 3′ appear to be extrusions of the wave. Then, Sample points 1, 2, 4 and 3 remain as extrema points. However, Sample points 2 and 4 are both categorized as maximum value, and sample point 4 locates next to the sample point 2. Thus, sample points 2 and 4 possess the same characteristic; there is no valid change form sample point 2 to sample point 4. Sample point 4 should be removed from extrema cube. Finally, sample points 1, 2 and 3 remain being considered as extrema point. Sample points 2′, 3′ and 4 are actually fake extrema points and being removed from extrema cubes.

Then, determining whether all seismic samples in the trace have been handled 210, if so, go to step 201 to determining whether all traces in the cube have been processed, otherwise, go back to step 204 to extract extrema points from the trace.

According to an embodiment of the invention, also as shown in FIG. 3, auto-estimating class number starts with using K-mean to cluster all extrema points to N classes 301. Then, computing Gaussian parameters of each cluster 302, and find the closest two clusters according to Gaussian parameters of the clusters 303. If the similarity of the two clusters is within a predetermined range, merging the two clusters and go back to step 302 to compute Gaussian parameters of all clusters including the merged cluster. If the Gaussian parameters of the two clusters are not within the predetermined range, outputting the class number 305.

According to an embodiment of the invention, auto-estimating class number includes using random sample coordinates as seeds for K-mean clustering.

According to an embodiment of the invention, for a one-attribute space of single dimension d, the similarity of two Gaussian distributed clusters in d dimension is presented as follow:
μₙ is the Gaussian μ parameter vector for cluster n
σₙ is the Gaussian σ parameter vector for cluster n
For clusters i and j
The length of μᵢ−μⱼ is

l=modulus(μᵢ−μⱼ)
where modulus( ) calculates the modulus of a vector
   The absolute value of direction vector from μⱼ to μᵢ is

d=normalize(abs(μᵢ−μⱼ))
where abs( ) calculates the absolute value of each component of a vector
   The threshold distance is presented as

t=c·modulus(d·(σᵢ+σⱼ))
where c is a scalar parameter to control how aggressive for merging, default to 1.6
where the second · dot product for vectors
   Then merge the two clusters, if (l<t) is true. Step 303 includes finding the closest two clusters according to Gaussian parameters of the clusters. The closeness of clusters i and cluster j is presented as:

closeness=l−t(the lower the value is, the closer the clusters will be)
wherein c is set to 1.0 when calculating t

Some embodiments of the invention relate to systems that implement the above described methods. A system of the invention may include a processor and a memory that store a program having instructions for causing the processor to perform the steps of a method of the invention. Such systems may be implemented on any computer (such as a personal computer or workstation) or any computing unit known in the art. Some embodiments of the invention relate to computer readable media, which store a program having instructions for causing the processor to perform the steps of a method of the invention.

Advantages of the invention may include one or more of the following. Methods of the invention use dynamic filtering of a large collection of geometric primitives to quickly isolate a desired subset of available geometric primitives. The filtering may be based on proximity to a selected point in 3D as well as a selected property of the object. This will facilitate analysis of complex data set to afford quick identification of useful information.

While the invention has been described with respect to a limited number of embodiments, those skilled in the art, having benefit of this disclosure, will appreciate that other embodiments can be envisioned that do not depart from the scope of the invention as disclosed herein. Accordingly, the scope of the invention shall be limited only by the attached claims.

What is claimed is:

1. A method for processing 3D seismic data set, comprising:
identifying extrema points from the 3D seismic data set;
removing artificial distortion from 3D seismic data set;
generating extrema cubes and derivatives along extrema points;
estimating a class number associated with the extrema points; and
determining number of classes and dynamically classifying extrema and extrema sequence.

2. The method of claim 1, wherein removing artificial distortion includes removing extrema points corresponding to useless dithering from the identified extrema points.

3. The method of claim 1, wherein removing artificial distortion includes removing extrema points corresponding to clamped values from the identified extrema points.

4. The method of claim 1, wherein removing artificial distortion includes removing extrema points corresponding to dead traces from the identified extrema points.

5. The method of claim 1, wherein auto-estimating class number includes K-mean clustering all extrema points to N clusters.

6. The method of claim 1, wherein auto-estimating class number includes calculating Gaussian parameters of each cluster and grouping the N clusters according to their Gaussian parameters.

7. The method of claim 1, wherein auto-estimating class number includes repeating merging two closest clusters if similarity of the two clusters in within a predetermined range.

8. The method of claim 1, wherein auto-estimating class number includes outputting the clusters group, if it is determined that the two clusters should not be merged.

9. A system for processing 3D seismic data, comprising a processor and a memory, wherein the memory stores a program having instructions for:
identifying extrema points from the 3D seismic data set;
removing artificial distortion from 3D seismic data set;
generating extrema cubes and derivatives along extrema points;
estimating a class number associated with the extrema points; and
determining number of classes for a dynamical extrema point classification.

10. A method for processing 3D seismic data set, comprising:
selecting a seismic trace from the 3D seismic data set;
removing dead trace data from the seismic trace;
extracting extrema points from the seismic trace;
removing extrema points by comparing distance between adjacent extrema points and characteristics of the adjacent extrema points; and
outputting remaining extrema points.

11. The method of claim 10, wherein comparing distance between adjacent extrema points includes selecting an extracted extrema point and removing the extracted extrema point from extrema cubes, if the extracted extrema point locates more than a predetermined distance from a previous extrema point of the seismic trace.

12. The method of claim 10, wherein comparing characteristics between adjacent extrema points includes removing the extracted extrema point from the extrema cubes, if the characteristics extracted extrema point do not have any valid change as compared to a previous extrema point.

13. The method of claim 10, wherein the characteristics comprises whether the extracted extrema point has maximum value or minimum value.

14. A method for processing 3D seismic data set, comprising:
extracting extrema points from the 3D seismic data set;
K-mean clustering the extracted extrema points into N clusters;
calculating Gaussian parameters of each cluster;
grouping clusters according to the Gaussian parameters of all clusters; and
outputting amount of groups as class number for extrema classification or extrema sequence classification.

15. The method of claim 14, wherein grouping clusters comprises finding closest two clusters according to their Gaussian parameters.

16. The method of claim 14, wherein grouping clusters comprises calculating the similarity of the two clusters and determining whether the similarity is in a predetermined range, if so, merge the two clusters into one cluster and calculating the Gaussian parameters of the merger the cluster.

17. The method of claim 14 further comprises repeating the step of finding closest two clusters according to the Gaussian parameters of all remaining clusters.
